(19) United States
(12) Patent Application Publication
(10) Pub. No.: US 2010/0038398 A1
(43) Pub. Date: Feb. 18, 2010

(54) Linkage Mechanism for Control Valve in Pneumatic Nail Guns

(76) Inventors: CHIA-SHENG LIANG, Taipei Hsien (TW); Yi-Hui Chen, Taipei Hsien (TW)

Correspondence Address: HDLS Patent & Trademark Services, P.O. BOX 220746, CHANTILLY, VA, 20153-0746, US

(21) Appl. No.: 12/193,017

(22) Filed: Aug. 17, 2008

(51) Int. Cl. B25C 1/04

(52) U.S. Cl. 227/8; 227/130; 251/279

(57) ABSTRACT

A linkage mechanism for a control valve in a nail gun is provided. The control valve is disposed on a main body of the nail gun. A valve plug of the control valve adjoins to a safety rod of the nail gun. A trigger valve is mounted on the main body and an outer trigger is disposed adjacent to the trigger valve. An inner trigger is pivotably disposed in the outer trigger. An end of a rod member is slidably disposed at a side of the outer trigger and another end of the rod member is connected between the valve plug and the safety rod with an arm. A stopping portion is formed at a middle portion of the rod member. The stopping portion is configured for pressing the outer trigger so as to drive the inner trigger to push the rod member, the arm, the valve plug and the safety rod to move along a nail driving direction of the nail gun. The present linkage mechanism can improve a stability of controlling of nail shooting action and a durability of the nail gun.

### BACKGROUND

The present invention relates to control devices for nail hitting of pneumatic nail guns, and particularly to a control device capable of controlling nail hitting action of nail guns according to thickness of workpiece.

Currently, pneumatic nail guns are widely used to join a workpiece (for example, a gasket) onto an object with a nail. The workpiece may include a through hole preformed on it. The users must align a nail with the through hole and then press the nail into the through hole and the object to fix the workpiece. To reduce difficulty of aligning, people developed a nail gun exposing a tip of the nail outside the nail gun.

In addition, different workpieces have different thickness. To provide ability of automatically detecting workpieces that are in predetermined thickness range in pneumatic nail guns, conventionally, the pneumatic nail gun includes a safety rod installed in a main passageway. The main passageway usually connects a trigger valve and a main valve. The safety rod includes a knocking member formed at a bottom end. When the safety rod reaches a predetermined height above the object, a control valve conducts pressurized air to open the main valve; as a result, the pressurized air drives a drive rod to hit the nail. The predetermined height includes a thickness of the workpiece or a depth of the through hole. The user can place a tip of the nail exposed from a drive track exit in the through hole. The tip is in contact with a surface of the object. The knocking member is sustained by the workpiece; the depth of the through hole is reflected by a relative distance between the tip and the knocking member. When a height of the knocking member is in a predetermined range, the control valve conduct pressurized air to switch the main valve to an open state, and then the pressurized air drives the drive rod to hit the nail.

US Patent Publication No. 20070075113 discloses a pneumatic nail gun having a control device for nail hitting action, which employs a swinging pole and a valve stem. A safety rod can drive the swinging pole. The swinging pole can block or release the valve stem. In other words, the safety rod can control blocking or releasing of the valve stem. As a result, the safety rod can also control the mail valve to open to start press nail. However, the valve stem is directly controlled by the pressurized air, the stability is relative low. Also, the swinging pole is located between the valve stem and the safety rod, the structure is too complex. It is difficult to maintain stability of nail hitting action.

### BRIEF SUMMARY

In order to overcome aforementioned disadvantages, an object of the present invention is to provide a linkage mechanism for a pneumatic nail gun, and more particularly, to provide a linkage mechanism that is configured for positioning a control valve at a predetermined position according to a practical thickness of a workpiece. As such, the control valve can control the pressurized gas to drive the nail gun to hit nail so as to improve a stability of controlling action of the nail gun and simplify a configuration of the nail gun for improving a durability of the nail gun.

In one embodiment, a linkage mechanism for a control valve in a nail gun is provided. The nail gun includes a main body, a safety rod, a trigger valve and an outer trigger. The control valve and the trigger valve are mounted in the main body. The control valve includes a valve plug adjoining the safety rod. The outer trigger is adjacent to the trigger valve.

The linkage mechanism includes an inner trigger pivotably disposed in the outer trigger; and a rod member. One end of the rod member is slidably disposed at a position near to the outer trigger and another end of the rod member is connected between the valve plug and the safety rod with an arm. A stopping portion is formed at a middle portion of the rod member. The stopping portion is configured for pressing the outer trigger so as to drive the inner trigger to push the rod member, the arm, the valve plug and the safety rod to move along a nail driving direction of the nail gun.

As such, the inner trigger can be driven to push the stopping portion by pressing the outer trigger such that the arm of the rod member drives the valve stem and the safety rod to move along the nail driving direction. In addition, the control valve switches to an open state when the safety rod moves to a predetermined height in the nail driving direction, and then the trigger valve is opened by triggering the trigger valve using the inner trigger thereby controlling the pressurized gas to drive the nail gun to hit nails. During this period, a valve stem of the trigger valve is configured for being pressed by the inner trigger when the outer trigger is triggered; the valve stem is a pivot of the inner trigger when the inner trigger pushes the stopping portion. The stopping portion serves as a pivot of the inner trigger when the rod member stops to move and the inner trigger pushes the valve stem of the trigger valve.

In the present linkage mechanism, the valve plug of the control valve can be directly driven by the inner trigger using the rod member and the arm so that the valve plug can move to a position that is capable of controlling the pressurized gas prior to nail driving motion and drive the safety rod to move to a predetermined position. As such, the control valve can control the pressurized gas to drive the nail gun to hit nail so as to improve a stability of controlling action of the nail gun by use of the rod member and the arm. In the present linkage mechanism, the components between the control valve and the outer trigger can also be reduced in complexity. As a result, a good stability of controlling action of the nail gun and a high durability of the nail gun can be achieved.

In addition, the linkage mechanism can further include a guiding portion formed on a fixing end of the outer trigger. An end of the rod member is slidably received in the guiding portion.

In another embodiment, the fixing end is formed on the main body. The guiding portion is a rod hole formed in the fixing end for receiving an end of the rod member.

In still another embodiment, the inner trigger includes a furcate claw portion, and the stopping portion is a step surface formed on the rod member near to a middle portion of the rod member. The claw portion is disposed on the rod member and is movable relative to the rod member. The claw portion is capable of pushing the step surface of the rod member so as to drive the rod member to move.

The present linkage mechanism will be described in detail with reference to FIGS as following:

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic view of an embodiment of the present invention;

FIG. 2 is a partially enlarged view of FIG. 1;

FIG. 3 is a perspective schematic view showing a configuration of a rod member and an inner trigger;

FIG. 4 is a schematic view showing a configuration of a safety rod of the present invention;

FIG. 5 is a cross sectional view showing a first air flow passage of the present invention;

FIG. 6 is a cross sectional view showing a second air flow passage of the present invention;

FIG. 7 is a cross sectional view of a control valve of the present invention;

FIG. 8 is a schematic view showing the control valve of FIG. 7;

FIG. 9 is a schematic view showing a use state of a knocking member of the present invention;

FIG. 9a is similar to FIG. 9, but showing another state of the knocking member;

FIG. 10 is similar to FIG. 9, but showing still another state of the knocking member;

FIG. 11 is a schematic view showing a use state of the safety rod and the valve stem of the present invention;

FIG. 12 is similar to FIG. 11, but showing another use state of the safety rod and the valve stem;

FIG. 13 is a schematic view showing a use state of a drive piston of the present invention;

FIG. 14 is similar to FIG. 11, but showing still another use state of the safety rod and the valve stem;

FIG. 15 is similar to FIG. 13, but showing another use state of the drive piston;

FIG. 16 is similar to FIG. 11, but showing yet another use state of the safety rod and the valve stem;

FIG. 17 is similar to FIG. 11, but showing another use state of the safety rod and the valve stem; and

FIG. 18 is similar to FIG. 17, but showing another use state.

### DETAILED DESCRIPTION

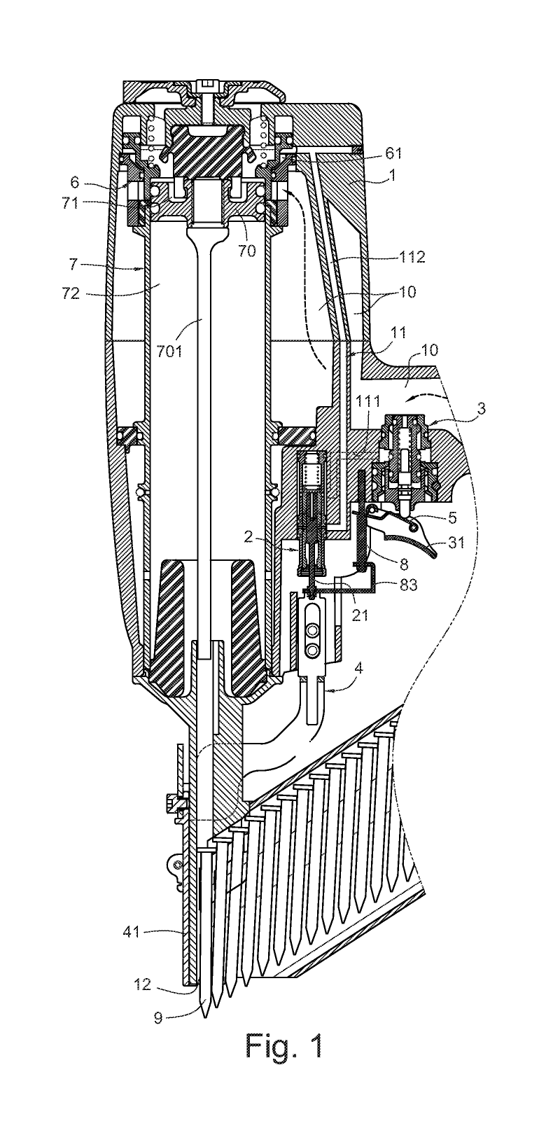

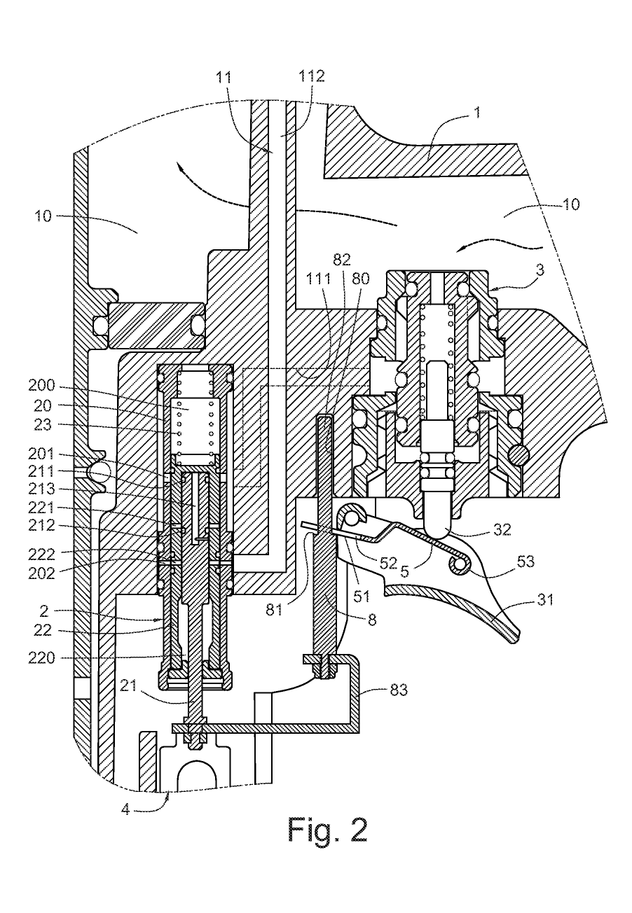

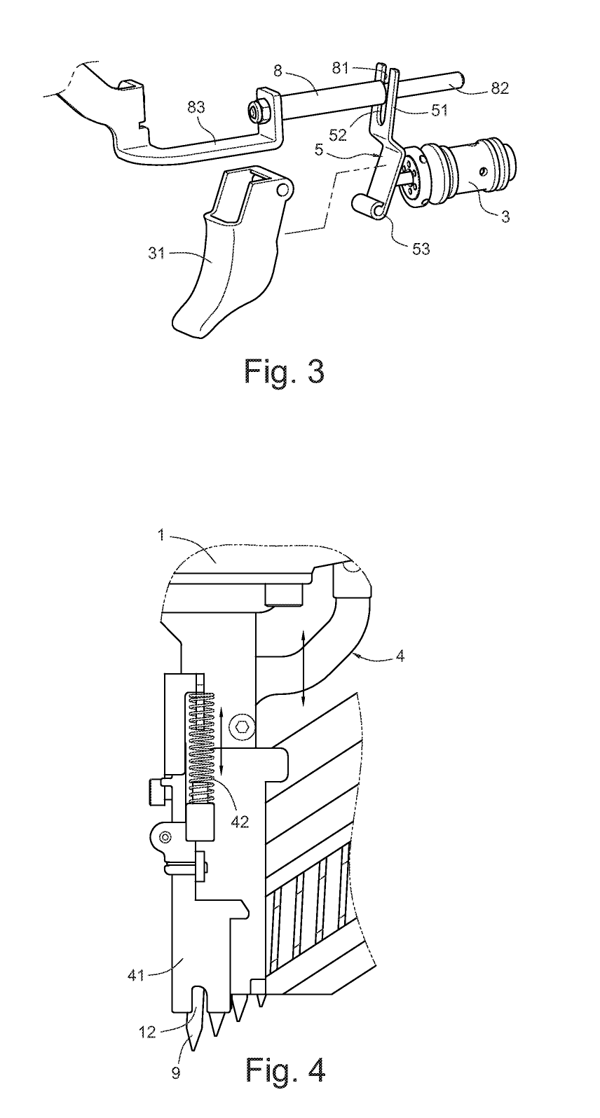

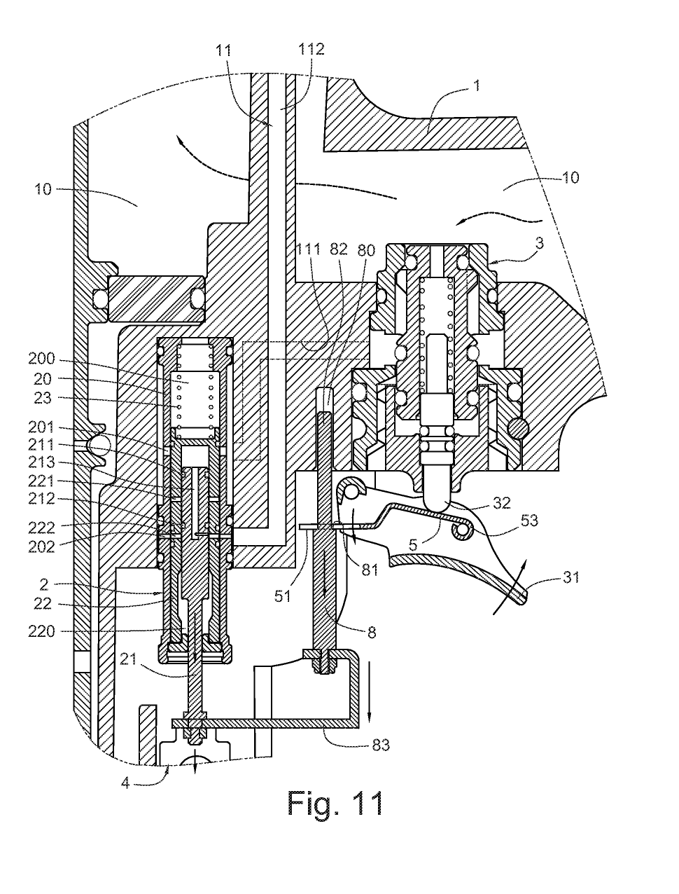

FIG. 1 illustrates a configuration of a linkage mechanism for a control valve in a pneumatic nail gun. Referring together to FIGS. 2 and 3, the pneumatic nail gun includes a main body 1, a control valve 2 and a trigger valve 3 mounted in the main body 1. The control valve 2 includes a valve plug 21. A bottom of the valve plug 21 adjoins a top of a safety rod 4. An outer trigger 31 near to the trigger valve 3 is pivotably mounted at a side thereof. An inner trigger 5 is pivotably disposed in the outer trigger 31. The inner trigger 5 can be moved by pressing the outer trigger 31 (as shown in FIG. 11). A guiding portion 80 is formed at a fixing end o near to the outer trigger 31. In the present embodiment, the fixing end is formed on the main body 1, and a top end of a rod member 8 is slidably received in the guiding portion 80. A bottom end of the rod member 8 is connected between the valve plug 21 and the safety rod 4 with an arm 83. The rod member 8 further includes a stopping portion 81 formed near a middle thereof. The stopping portion 81 is capable of being pressed by the inner trigger 5.

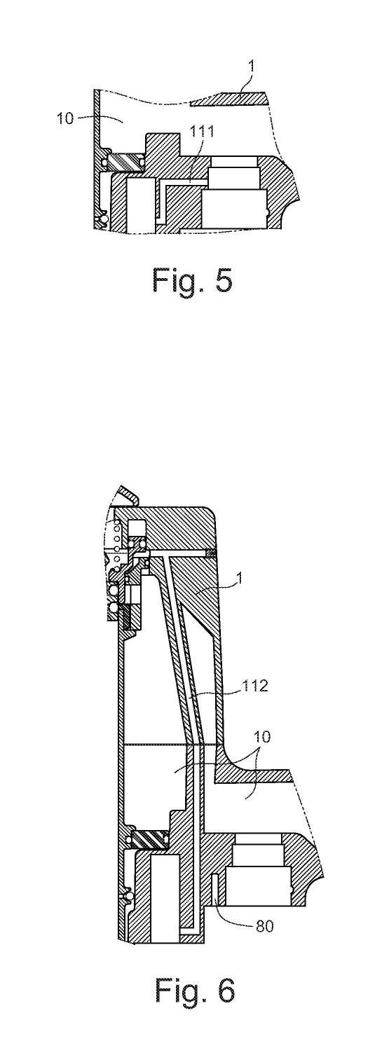

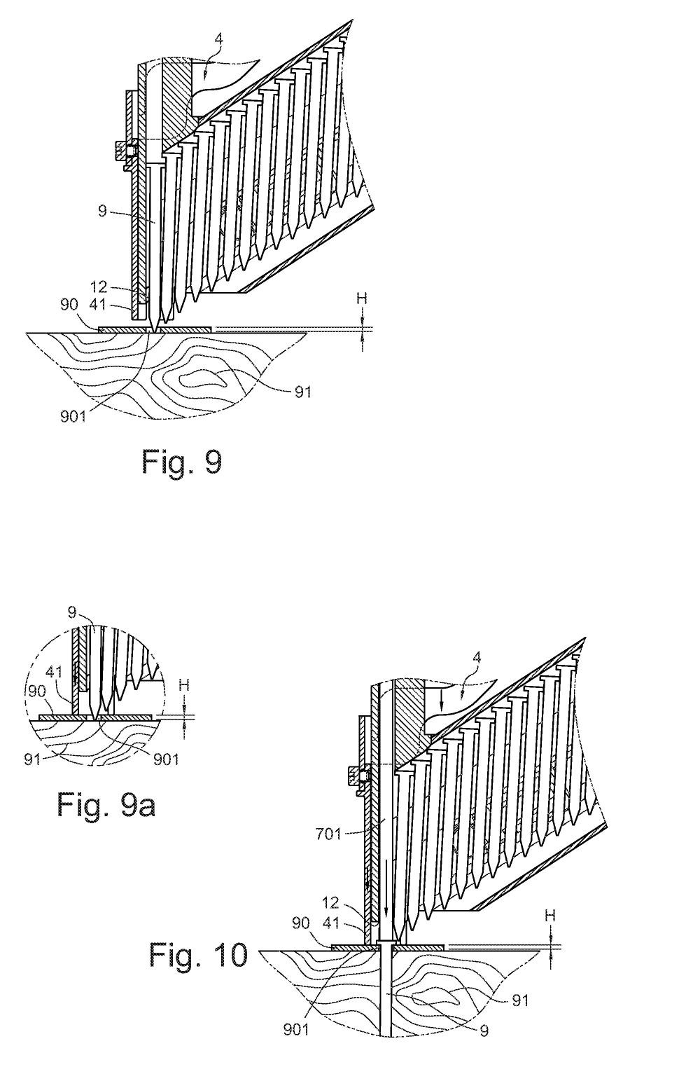

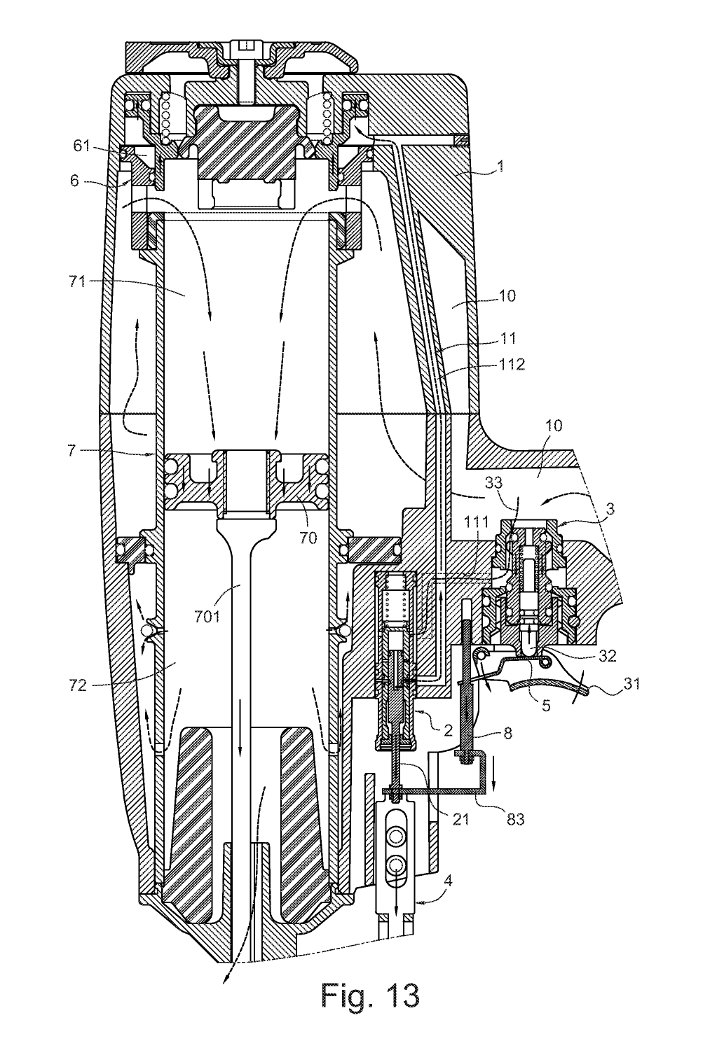

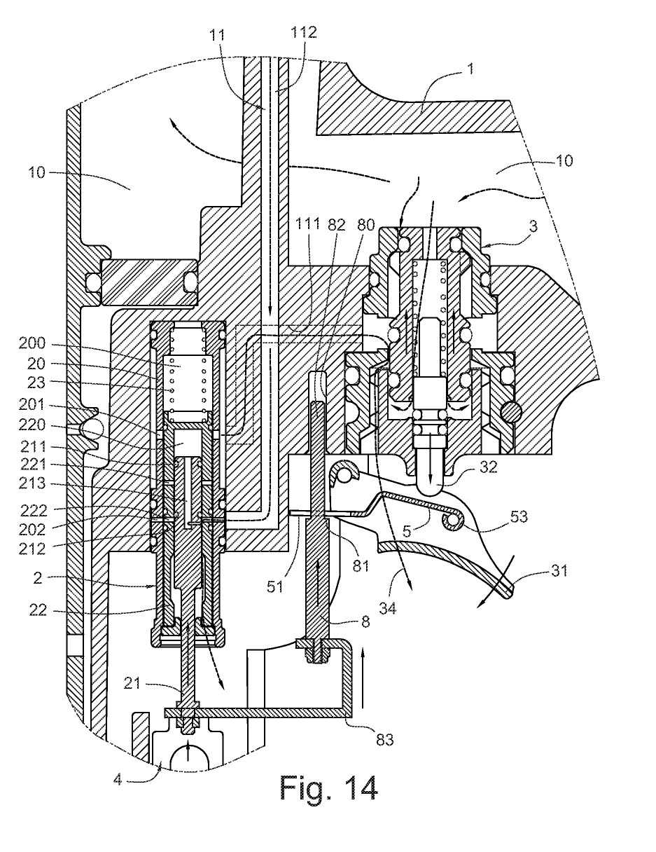

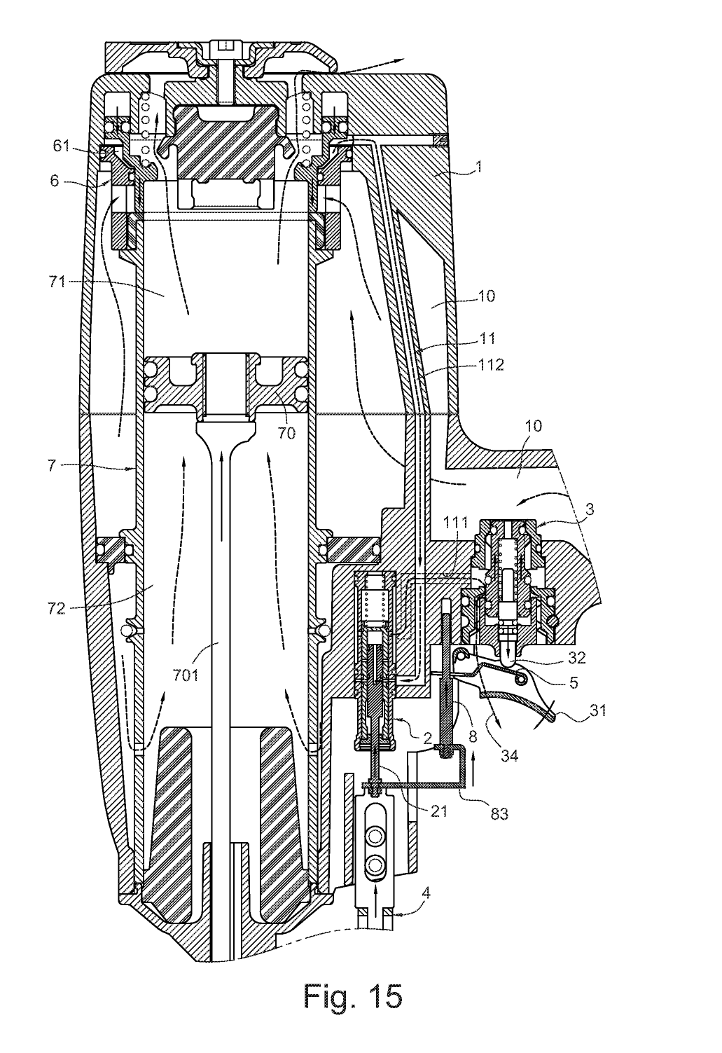

The main body 1 has a main air flow passage 11 (as show in FIGS. 1, 2, 5 and 6) which includes a first air flow passage 111 and a second air flow passage 112. The first air flow passage 111 connects the trigger valve 3 to the control valve 2. The second air flow passage 112 connects the control valve 2 to a main valve 6 disposed in an upper portion of the main body 1. The main body 1 also includes a reservoir 10 and a cylinder 7. The reservoir 10 surrounds the main valve 6 and the cylinder 7. The reservoir 10 contains pressurized air maintained at a constant high pressure. The cylinder 7 is adjacent to a bottom end of the main valve 6. Arranged at a bottom end of the safety rod 4 is a knocking member 41 for pressing a workpiece 90 (as shown in FIGS. 9 and 9a) for pushing a workpiece 90 to be nailed. The knocking member 41 extends to exceed a drive track exit 12 formed at a bottom of the main body 1. The main valve 6 can receive actuation from the pressurized air in the main air flow passage 11 to control communication between the reservoir 10 and the cylinder 3 (as shown in FIGS. 13 and 15). The trigger valve 3 can conduct the pressurized air in the reservoir 10 to pass through the control valve 2 and open the main valve 6. As a result, the pressurized air drives the nail gun to hit a nail.

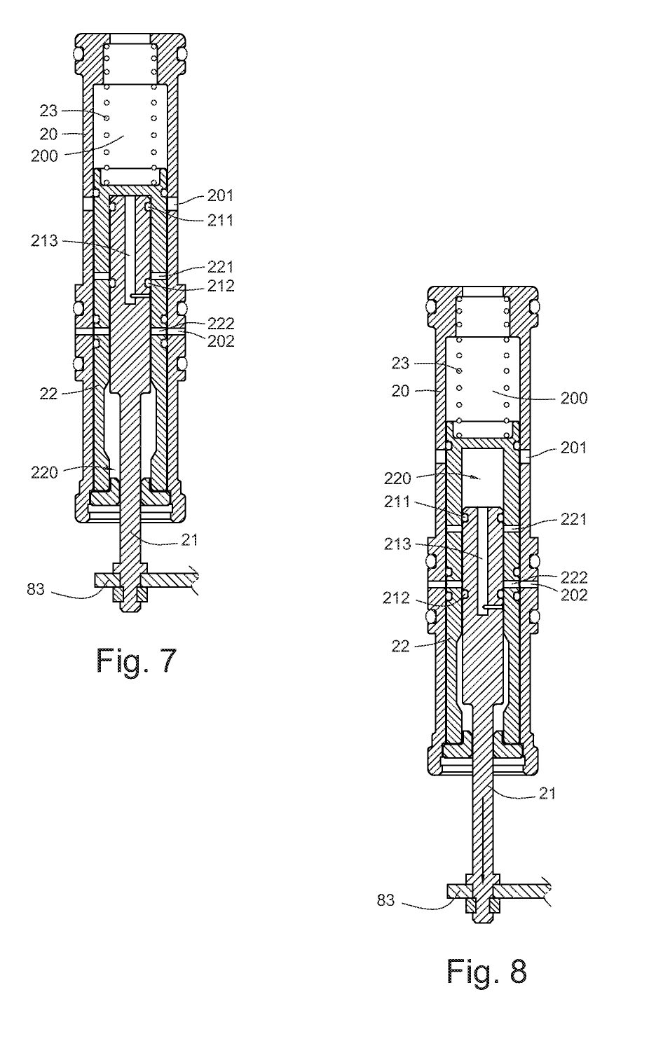

The control valve 2 includes a valve base 20 mounted on the main body 1 (as shown in FIGS. 1 and 2). The valve base 20 provides a slide groove 200 therein. In addition, the valve base 20 also provides a number of air inlets 201 connected to the first air flow passage 111 (as shown in FIG. 7) and a number of air outlets 202 connected to the second air flow passage 112. A valve sleeve 22 is slidably received in the slide groove 200. Arranged between a top of the valve sleeve 22 and an inner sidewall of the slide groove 200 is a spring 23 for driving the valve sleeve 22 to move downwardly. A guide groove 220 is formed in the slide sleeve 22. A number of first air holes 221 and a number of second air holes 222 are formed between the inner and outer side surfaces of the valve sleeve 22. The first air holes 221 are connected to the first air flow passage 111 with the air inlets 201 and the second air holes 222 are connected to the second air flow passage 112 with the air outlets 202. The valve plug 21 is slidably received in the guide groove 220 and extends over the valve base 20 to adjoin the top of the safety rod 4. An upper sealing ring 211 is disposed on the valve plug 21 and above the first air hole 221, and a lower sealing ring 212 disposed between the first air hole 221 and the second air hole 222. The lower sealing ring 212 can isolate the first air flow passage 111 and the second air flow passage 112. A through hole 213 if formed between the top of the valve plug 21 and a side surface of the valve plug that is below the lower sealing ring 212 to connect the top of the valve plug 21 to the outer atmosphere so as to balancing an air pressure difference between the top of the valve plug 21 and the outer atmosphere. As a result, the valve 21 can move reciprocally.

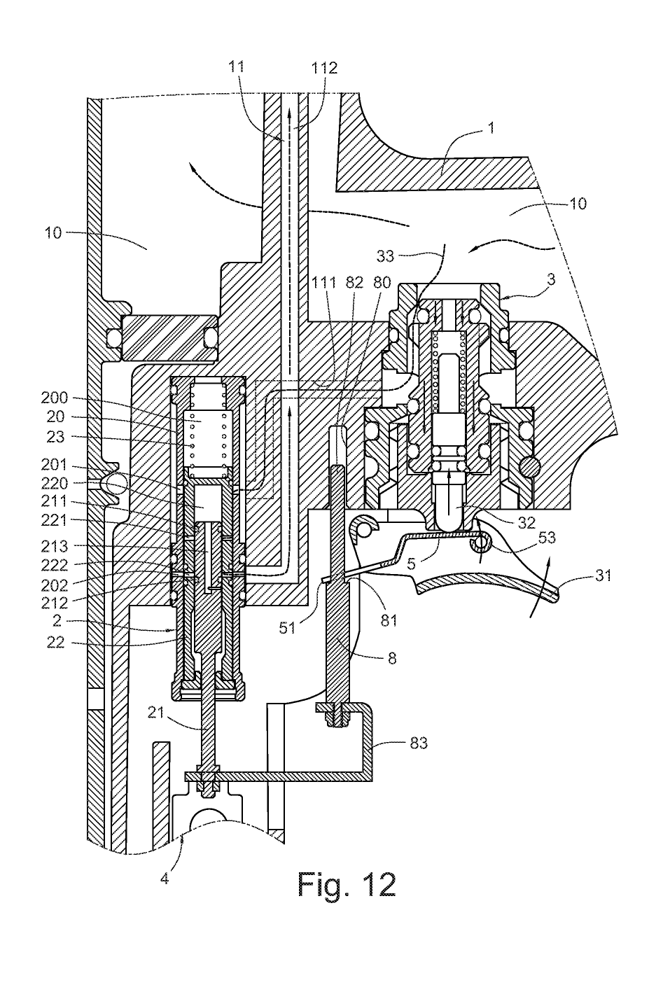

The main valve 6 has a main chamber 61 (see FIG. 1) that is connected to the second air flow passage 112. The main chamber 61 can collect the pressurized air from the second air flow passage 112 to drive the main valve 6 to open a top of the cylinder 7 (as shown in FIG. 13), and guide the pressurized gas in the reservoir 10 to enter the cylinder 7. The cylinder 7 slidably receives a drive piston 70, which divides an inner space of the cylinder 7 into an upper air chamber 71 and a lower air chamber 72. A bottom of the drive piston 70 is connected with a drive rod 701. The trigger valve 3 includes a valve stem 32 (as shown in FIG. 2) that is capable of being pressed and released by the trigger 31. By moving the valve stem 32 reciprocally, an air introducing passage 33 (as shown in FIG. 12) that connects the reservoir 10 to the main air flow passage 11 and an air discharging passage 34 (as shown in FIG. 14) that connects the main air flow passage 11 and the outer atmosphere are alternatively formed in the trigger valve 3. Arranged between a side end of the safety rod 4 and the bottom of the main body 1 is a spring 42 (see FIG. 4) configured for driving the safety rod 4 to move the knocking member 41, the valve plug 21, the arm 83 and the rod member 8 upwardly so that the nail 9 in the nail drive groove at a bottom end of the main body 1 is exposed from the drive track exit 12 and the knocking member 41.

However, it is to be understood above-mentioned configuration and structure of control valve 2, the trigger valve 3, the main valve 6 and the cylinder 7 are illustrative rather than to limit the present invention. In other words, any control mechanism that utilizes the trigger valve 3 to guide pressurized gas to pass through the control valve 2, and driving the main valve 6 to open so as to make the cylinder 7 work, including the control valve, the trigger valve, and the main valve in the prior art, can also be used in the present invention.

The present linkage mechanism will be described in more detail as following;

In the present embodiment, the rod member 8 is in a column shape with step on it, and an end portion 82 is formed at a top of the rod member 8 (as shown in FIGS. 2 and 3) and a step surface is formed near to a middle of the rod member. The end portion 82 is capable of being slidably received in the guiding portion 80 and the step surface serves as the stopping portion 81.

In the present embodiment, the guiding portion 80 is a rod hole formed in the fixing end of the main body 1 (see FIGS. 2, 3 and 6) for receiving and guiding the end portion 82 of the rod member 8.

The inner trigger 5 includes a furcate claw portion 51 (as shown in FIGS. 2 and 3) formed at one end and a pivot connecting portion 53 formed at another end for pivotably mounting the inner trigger 5 in the outer trigger 31 such that the inner trigger 5 can swing in the outer trigger 31. The claw portion 51 is disposed on the rod member 8 and is movable relative to the rod member 8. The claw portion 51 is capable of pushing the step surface of the rod member 8 so as to drive the rod member to move. The claw portion 51 further includes a groove 52 for receiving the end portion 82 of the rod member 8. The end portion 82 can move reciprocally in the groove 52.

The operation state of the present linkage mechanism will be described in detail with reference to FIGS. 11 to 18 as following:

When a user try to join a workpiece 90 onto another object 91 using the pneumatic nail gun, firstly, the user can insert a tip of a nail 9 exposed from the nail exit 12 and the knocking member 41 into a through hole 901 preformed in the workpiece 90 (as shown in FIG. 9). The tip of the nail 9 can contact with the object 91. At a same time, the knocking member 41 is disposed above the workpiece 90. When the trigger 31 is triggered by the user (as shown in FIG. 11) the trigger 31 press a portion of the inner trigger 5 that is adjacent to the pivot connecting portion 53 to trigger the valve stem 32 of the trigger valve 3, and drive the claw portion 51 of the inner trigger 5 to press the stopping portion 81. Simultaneously, because a pressure that the pressurized gas in the reservoir 10 applies to the trigger valve is greater than a pressure that the spring 42 (see FIG. 4) applies to the safety rod 4, the valve plug 21, the arm 83 and the rod member 8, the claw portion 51 of the inner trigger 5 swings around the valve stem 32 to press the stopping portion 81 and the rod member 8 to move downwardly. As a result, the arm 83 of the rod member 8 drives the valve plug 21 and the safety rod 4 moves along a nail driving direction. When the knocking member 41 of the safety rod 4 reaches a predetermined height H above the object 91, the workpiece 90 blocks the knocking member 41 (as shown in FIG. 9a). During this period, the end portion 82 of the rod member 8 is guided by the guiding portion 80 to move steadily. The predetermined height H includes thickness of the workpiece 90 or depth of the through hole 901. The relative positions of the first air holes 221, the second air holes 222, the upper sealing ring 211, and the middle sealing ring 212 are designed according to the predetermined height H. As such, the distance between the tip of the nail 9 and the bottom surface of the knocking member 41 reflects the depth of the through hole 901. When the depth of the through hole 901 is in a predetermined range, the valve plug 21 moves the upper sealing ring 211 above the first air holes 221 (as shown in FIG. 8) and moves the middle sealing ring 212 below the second air holes 222. As a result, the valve plug 21 connects the air inlets 201, the first air holes 221, the air flow passage between the first air holes 221 and the second air holes 222, the second air holes 222, and the air outlets 202. The first air flow passage 111 is in communication with the second air flow passage 112.

Sequentially, the outer trigger 31 drives a portion of the inner trigger 5 that is adjacent to the pivot connecting portion 53 to press the valve stem 32 of the trigger valve 3 (as shown in FIG. 12). The knocking member 41 of the rod member 8 is blocked by the surface of the workpiece 90, thus, the rod member 8 stops to move and a portion of the inner trigger 5 that near to the pivot connecting portion 53 utilizes the stopping portion 81 as a pivot to press the valve stem 32 thereby driving the trigger valve 3 to open. As a result, the pressurized air in the reservoir 10 passes through the air introducing passage 33, the first air flow passage 111, the air inlets 201, the first air holes 221, the second air holes 222, the air outlets 202 and finally enters the second air flow passage 112 and the main chamber 61 of the main valve 6 (as shown in FIG. 13). The pressurized air in the main chamber 61 drives the main valve to open the top end of the cylinder 7 and the pressurized air from the reservoir 10 enters the upper cylinder chamber 71 to drive the drive piston 70 and the drive rod 701 to move downwardly. The drive rod 701 hit the nail 9 and the nail 9 is pressed to pass through the through hole 901 and into the object 91 (as shown in FIG. 10). The nail 9 joins the workpieces 90 onto the object 91 (as shown in FIG. 10). As such, the safety rod 4 and the knocking member 41 can reflect thickness of the workpiece 90 or the depth of the through hole 901, the valve plug 21 of the control valve 2 can sense the height of the safety rod 4 and selectively conduct the pressurized air to drive the drive rod according to the height of the safety rod 4.

When the trigger 31 is released by the user (as shown in FIG. 14), the pressurized air in the reservoir 10 will drive the trigger valve 3 to close itself, the air introducing passage 33 is closed and the air discharging passage 34 is opened. The pressurized air in the reservoir 10 can't enter the main chamber 61 through the trigger valve 3, the main air flow passage 11, the control valve 2. In addition, the pressurized air in the main chamber 61, the main air flow passage 11 and the control valve 2 vents out of the nail gun from the air discharging passage 34 (as shown in FIG. 15). The pressurized air in the reservoir 10 drives the main valve 6 to close the top end of the cylinder 7, the piston 70 return to its original position. Simultaneously, the outer trigger 31 drives the inner trigger 5 to reset thereby releasing the stopping portion 81. The spring 42 (as shown in FIG. 4) drives the safety rod 4, the knocking member 41, the valve plug 21, the arm 83 and the rod member 8 to reset their positions thereby isolating the first air flow passage 111 and the second air flow passage 112 (as shown in FIG. 2). During this period, the end portion 82 of the rod member 8 is guided by the guiding portion 80 to move steadily.

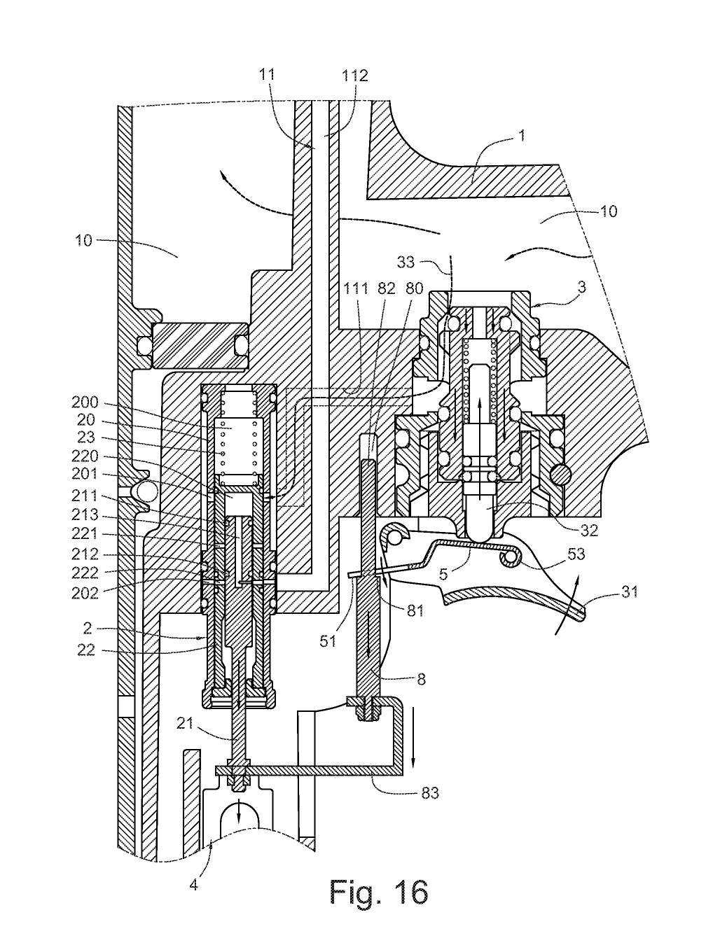

In addition, if the thickness of the workpiece 90 or the depth of the through hole 901 is larger than the predetermined height H, the displacement of the safety rod 4 reduces. In this instance, referring to FIG. 16, when the user actuate the outer trigger 31, the outer trigger 31 will firstly drive the inner trigger 5 to push the rod member 8, the arm 83, the valve plug 21, the safety rod 4 and the knocking member 41 to move along the nail driving direction to a position doesn't reach a predetermined range of the height H thereby being stopped by the surface of the workpiece. As such, the valve plug 21 moves the upper sealing ring 211 to a position above the first air holes 221, and the middle sealing ring 212 to a position between the first air holes 221 and the second air holes 222. The upper sealing ring 211 and the middle sealing ring 212 separate the first air flow passage 111 from the second air flow passage 112. Sequentially, the outer trigger 31 also drives the inner trigger 5 to open the trigger valve 3, the pressurized air in the reservoir 10 also passes through the air introducing passage 33, the first air flow passage 111, and then enters the air inlets 201 of the control valve 2. However, the control valve 2 separates the first air flow passage 111 and the second air flow passage 112, the nail gun stop to drive the nail 9. In other words, the nail gun is braked.

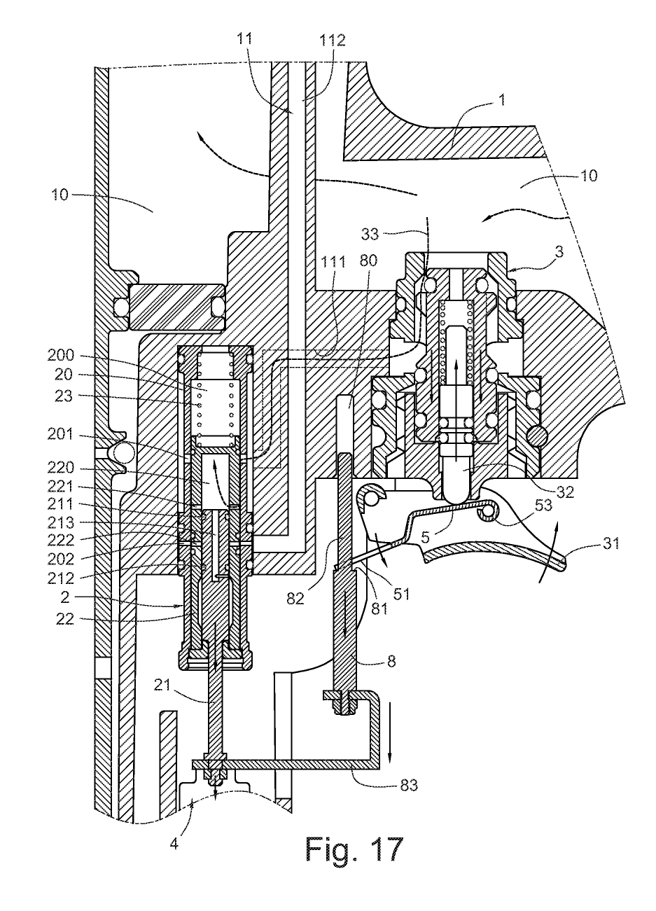

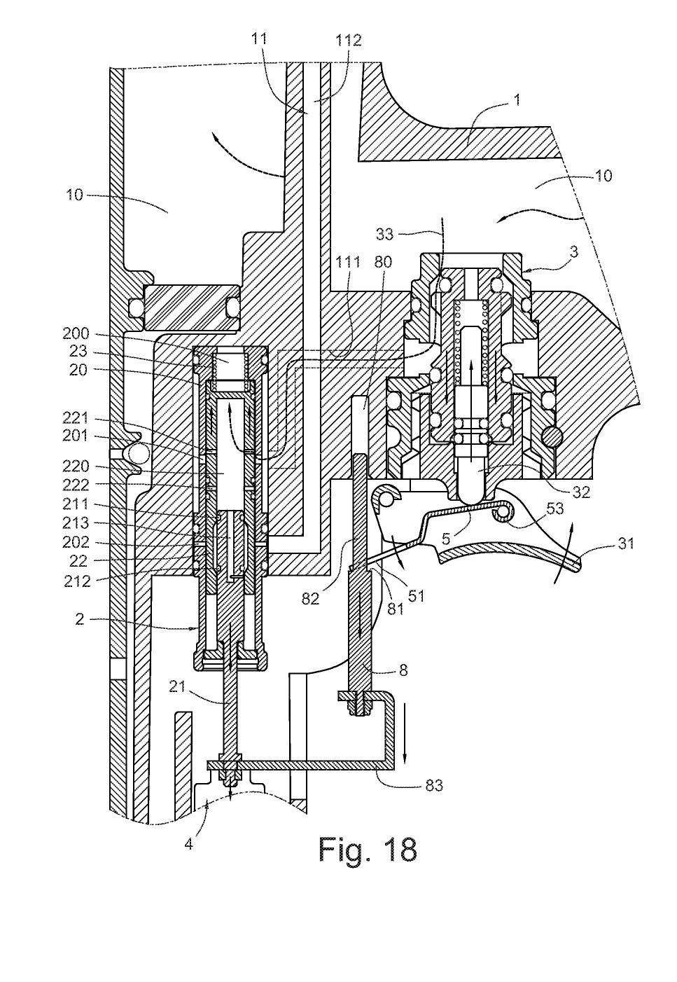

In addition, if the thickness of the workpiece 90 or the depth of the through hole 901 is less than the predetermined height H, the displacement of the safety rod 4 and the valve plug 21 increases. In this instance, when the user actuate the trigger 31 (as shown in FIG. 17), the outer trigger 31 will firstly drive the inner trigger 5 to push the rod member 8, the arm 83, the valve plug 21, the safety rod 4 and the knocking member 41 to move along the nail driving direction to a position exceeding a predetermined range of the height H thereby being stopped by the surface of the workpiece. As such, the valve 21 moves the upper sealing ring 211 to a position below the first air holes 221, and the middle sealing ring 212 to a position below the second air holes 222. The upper sealing ring 211 and the middle sealing ring 212 separate the first air flow passage 111 from the second air flow passage 112. Sequentially, the outer trigger 31 also drives the inner trigger 5 to open the trigger valve 3, the pressurized air in the reservoir 10 also passes through the air introducing passage 33, the first air flow passage 111, and then enters the air inlets 201 of the control valve 2, and further enters the guide groove 220 formed at a top of the valve plug 21 through the first air holes 221. The pressurized air drives the valve sleeve 22 to overcome the elastic force applied by the spring 23 thereby moving upwardly (as shown in FIG. 18) such that the upper sealing ring 211 and the middle sealing ring 212 are below the second air holes 222. The second air holes 222 are isolated from the second air flow passage 112 thereby breaking nail driving motion. If the user try to directly press the nail 9 into the object 91, the knocking member 41 of the safety rod 4 will move downwardly to a position exceeding the predetermined height H; in the other case, if the user triggers the outer trigger 31 by a mistake, the knocking member 41 of the safety rod 4 will also move to a position exceeding the predetermined height H. In these instances, the pressurized air will drive the valve sleeve 22 to move upwardly. As a result, the upper sealing ring 211 and the middle sealing ring 212 are below the second air holes 222 and the nail gun is braked.

As mentioned above, the valve plug 21 of the control valve 2 can be directly driven by the inner trigger 5 using the rod member 8 and the arm 83 so that the valve plug 21 can move to a position that is capable of controlling the pressurized gas prior to nail driving motion and drive the safety rod 4 to move to a predetermined position. As such, the control valve 2 can control the pressurized gas to drive the nail gun to hit nail so as to improve a stability of controlling action of the nail gun by use of the rod member 8 and the arm 83. In the present linkage mechanism, the components between the control valve 2 and the outer trigger 31 can also be reduced in complexity. As a result, a good stability of controlling action of the nail gun by use of the rod member 8 and the arm 83 can be achieved.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A linkage mechanism for a control valve in a nail gun, the nail gun comprising a main body, a safety rod, a trigger valve and an outer trigger, the control valve and the trigger valve being mounted in the main body, the control valve comprising a valve plug adjoining the safety rod, the outer trigger being adjacent to the trigger valve, the linkage mechanism comprising:
an inner trigger pivotably disposed in the outer trigger; and
a rod member, one end of the rod member being slidably at a position near to the outer trigger and another end of the rod member being connected between the valve plug and the safety rod with an arm, a stopping portion being formed at a middle portion of the rod member, the stopping portion being configured for pressing the outer trigger so as to drive the inner trigger to push the rod member, the arm, the valve plug and the safety rod to move along a nail driving direction of the nail gun.

2. The linkage mechanism for a control valve in a nail gun as claimed in claim 1, further comprising a guiding portion formed at a fixing end near to the outer trigger, one end of the rod member being slidably received in the guiding portion.

3. The linkage mechanism for a control valve in a nail gun as claimed in claim 2, wherein the fixing end is formed on the main body, the guiding portion being a rod hole formed in the fixing end, the rod hole being configured for receiving one end of the rod member.

4. The linkage mechanism for a control valve in a nail gun as claimed in claim 1, wherein a claw portion is formed at an end of the inner trigger, the claw portion being configured for pressing the stopping portion.

5. The linkage mechanism for a control valve in a nail gun as claimed in claim 4, wherein the stopping portion is a step surface formed on a middle portion of the rod member, the step surface being configured for engaging with the claw portion and pushing the rod member to move.

6. The linkage mechanism for a control valve in a nail gun as claimed in claim 1, wherein the trigger valve comprises a valve stem configured for being pressed by the inner trigger when the outer trigger is triggered, the valve stem being a pivot of the inner trigger when the inner trigger pushes the stopping portion.

7. The linkage mechanism for a control valve in a nail gun as claimed in claim 1, wherein the stopping portion serves as a pivot of the inner trigger when the rod member stops to move and the inner trigger pushes the valve stem of the trigger valve.
